(19) United States
(12) Patent Application Publication
(10) Pub. No.: US 2002/0027365 A1
(43) Pub. Date: Mar. 7, 2002

(54) Electromagnetic vehicle closure panel cinching mechanism

(76) Inventors: Lloyd Walker Rogers JR., Shelby Township, MI (US); Michael Antonio Ciavaglia, Dearborn, MI (US); William L. Priest, Royal Oak, MI (US); Mark Duane Nicholas, Waterford, MI (US)

Correspondence Address: PATRICK M. GRIFFIN, DELPHI TECHNOLOGIES, INC., P.O. Box 5052, Mail Code: 480-414-420, Troy, MI, 48007-5052, US

(21) Appl. No.: 09/848,461

(22) Filed: May 3, 2001

Related U.S. Application Data
(60) Provisional application No. 60/230,594, filed on Sep. 6, 2000.

(51) Int. Cl. E05C 3/06

(52) U.S. Cl. 292/201

(57) ABSTRACT

An improved lift gate power cincher uses and electromagnetic pulling action, instead of a mechanical hooking action, to pull the lift gate closed, thereby eliminating the need for a manual over ride in the event of electrical failure. An electromagnet fixed to the gate power retracts and re extends, activated as it retracts, and de activated as it re extends to a cinch ready position. The magnet pulls face to face on a vehicle mounted steel plate, and, therefore, simply releases in the event that power fails. The plate is also spring loaded to compress and yield if the power fails with the magnet not fully retracted, so that the gate may still be shut.

This application claims the benefit of provisional patent application Ser. No. 60/230,594 filed Sep. 6, 2000.

### TECHNICAL FIELD

This invention relates to automotive powered door cinching mechanisms in general, and specifically to an electromagnetic cinching mechanism that does not require a manual over ride means.

### BACKGROUND OF THE INVENTION

Vehicle closure panels, such as doors and lift gates, close freely, with very little resistance, until they reach a substantially closed position where mechanical latches begin to engage and weather strips begin to compress. The mechanical latches typically consist of spring loaded, rotatable fork bolts, which require a certain closing force to fully engage. The closing force applied over a pre determined travel distance sufficient to fully rotate the latch fork bolts around strikers and completely compress the weather strips. The final closing force was provided, in the past, totally by a manual push or pull. Such latches, when released by a suitable release mechanism, allow the door to quickly spring partially open, as the stored energy of the spring loaded latches and compressed weather strips is released.

Powered mechanisms have been proposed and used for sometime which provide the force needed for the final closing or “cinching” motion. That is, they automatically move the lift gate or door over the so called “travel distance” that fully engages the latches. The basic operation of most such devices consists of simply making the passive latch active, so that it pulls itself closed, although the mechanisms can be rather complex. Generally, the power is provided by an electric motor, and some component is mechanically hooked onto or around another part to make the physical connection or “grab” that allows the pulling action to occur. The powered pulling action is reversed to open the panel.

Obviously, some kind of manual over ride mechanism is needed to allow the panel to be opened if the vehicle electrical power fails. An example may be seen in U.S. Pat. No. 6,123,372. Adding a manual over ride onto the already somewhat complex electromechanical cinching mechanism only adds to the cost and complexity of the total package.

### SUMMARY OF THE INVENTION

The invention provides a simplified electromagnetic alternative to an electromechanical cinching mechanism, which eliminates the “hooking” action, and so eliminates the need for a manual over ride in the event of a power failure.

In the preferred embodiment disclosed, an electromagnet is mounted within a lift gate interior on a powered prime mover, such as an electric motor and jackscrew, that allows it to be driven back and forth over a sufficient stroke to cover the “travel distance” as defined above. When activated, the magnet also creates sufficient attractive force to provide the needed closing force. On the vehicle, a ferrous plate or the like is located so as to engage the electromagnet just as it reaches the “cinch ready” position. A first circuit, when energized, activates the electromagnet and the motor to run in one direction, while a second circuit, when energized, runs the motor and de activated magnet back in the opposite direction.

A sensor and switch system is provided which, in general, senses whether the lift gate is fully open, fully closed, or at the substantially closed position, and switches back and forth between the two circuits accordingly. Specifically, when the door moves from the open to the cinch ready position, the motion energizes the selected, but not yet energized, first circuit, which activates the electromagnet and its drive motor allowing it to pull the lift gate in. At the fully closed position, the motor is turned off, the mechanical latches become fully engaged, and the system switches to the second circuit, without yet energizing it. As the mechanical latches are released and the lift gate springs quickly back out, the sensor and switch system now energizes the second circuit to drive the de activated electromagnet back out to its starting position, ready to cinch the door again. The re advancing of the magnet also switches back to the first circuit, without yet energizing it, so that it can be re energized when the open door again is moved to the cinch ready position.

Since the pulling closed motion results from a simple, surface to surface magnetic pull, there is no mechanical “hooking” action to be reversed in the event of electrical failure. The magnet simply will not activate. Therefore, if the door is closed at the time, it can be opened mechanically just by releasing the conventional latches. In addition, should the failure occur when the lift gate is opened and the magnet is advanced to its cinch ready position, the vehicle mounted plate is spring loaded so as to allow it to compress. Therefore, the lift gate is not blocked from being manually pushed shut. The “over slam” spring also conveniently accommodates any face to face misalignment between magnet and plate that may occur during build.

### BRIEF DESCRIPTION OF THE DRAWINGS

These and other features will appear from the following written description, and from the drawings, in which:

FIG. 1 is a perspective view of the back of a vehicle incorporating the invention;

FIG. 2A is a plan view partly in cross section of a preferred embodiment of the invention with the door approaching first contact;

FIG. 2B is a schematic circuit diagram corresponding to FIG. 2A;

FIG. 3A shows the invention at the point of first contact between electromagnet and plate, as the cinching action commences;

FIG. 3B is the circuit diagram corresponding to FIG. 3A;

FIG. 4 shows the invention near the end of the cinching motion;

FIG. 5A shows the invention at the end of the cinching operation;

FIG. 6A shows the invention as the door is released and pops partially open;

FIG. 6B is the circuit diagram corresponding to FIG. 6A;

FIG. 7 shows the invention moved almost all of the way back toward the cinch ready position, after the door has been released;

FIG. 8A shows the invention moved all the way back to the cinch ready position;

FIG. 8B is the circuit diagram corresponding to FIG. 8A;

FIG. 9 shows the invention with the door having been manually closed after a power failure in the cinching mechanism.

### DESCRIPTION OF THE PREFERRED EMBODIMENT

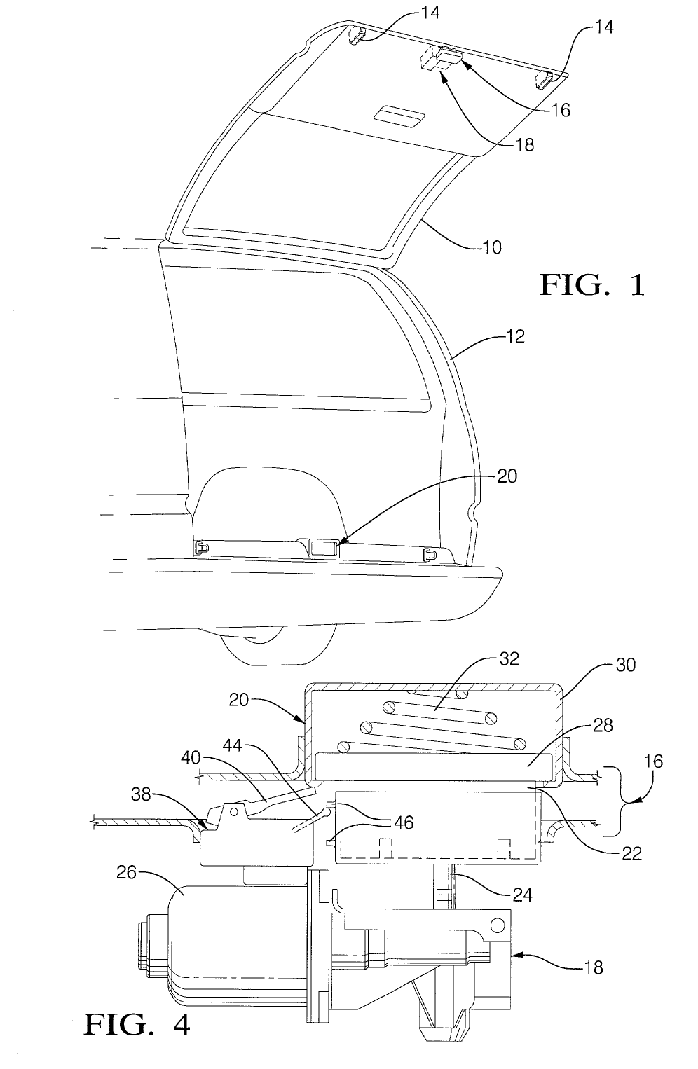

Referring first to FIG. 1, the invention is incorporated in a vehicle closure panel, which, in general, may be anything that opens and closes, but is specifically disclosed as a rear lift gate 10 that swings back and forth within a rear opening defined by vehicle body 12. Lift gate 10 swings between fully open and fully closed positions, and moves with little resistance until a pair of conventional, mechanical latches 14 are encountered. As is typical, latches 14 require a significant closing force to fully latch, applied over a pre determined distance, typically around ten mm, which may be termed the travel distance. The same latches 14 can be released to quickly “pop” the lift gate 10 partially open. As the lift gate 10 closes, a non illustrated weather strip also is compressed, adding to the total closing force needed. Conventionally, such closing force is simply applied with a manual push or pull. Recently, however, powered electro mechanical devices or “cinching mechanisms” have been provided to automatically pull the lift gate fully shut or “cinch” it. The invention provides an electromagnetic alternative to conventional electro mechanical devices.

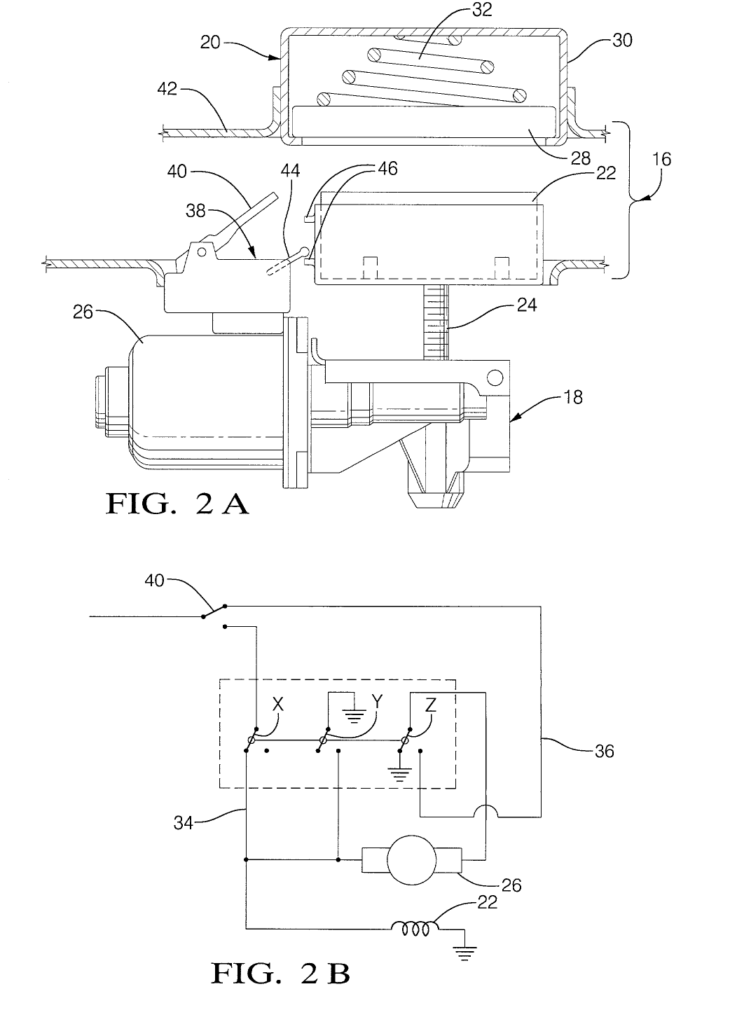

Referring next to FIGS. 1 and 2A, the invention, indicated generally at 16, consists of two basic parts, an electromagnet driver, indicated generally at 18, and a passive magnetic plate assembly, indicated generally at 20. The two basic parts 18 and 20 are mounted one to the lift gate 10 and one to the vehicle body 12. Most conveniently, as shown, the electromagnetic driver 18 is mounted to and within the hollow cavity of the lift gate 10, and the magnetic plate structure 20 to the vehicle body 12. It should also be noted that the cinching mechanism 16 is separate and independent from the latches 14, and is not, in and of itself, a latch per se. It's sole function is to assist the final closing action of the latches 14 and, should electric power fail, the latches 14 can be operated without any interference from the fully independent cinching mechanism 16, as will be described below.

Referring next to FIG. 2A, driver 18 includes an electromagnet 22 mounted on a jack screw 24 that can be driven back and forth by a reversible electric motor 26, over the travel distance described above. When energized, the motor 26 is capable of providing, and the electromagnet 24 is capable of applying, the closing force needed to engage the latches 14 and to fully close the lift gate 10. The plate assembly 20 includes a ferrous metal plate 28 that is spring loaded out within an open sided box 30, by compression spring 32, to the position shown. Box 30 is fixed to the vehicle body 12, in a location such that, as lift gate 10 is closed, the face of magnet 22 will contact the face of plate 28, clear of the opening in box 30, just as the latches 14 are contacted. Therefore, if the magnet 22 were to be pushed into plate 28, it would compress spring 32 and move inside of box 30. Box 30 is deep enough to allow spring 32 to depress by at least the travel distance noted above, and ideally a bit more. However, if the face of magnet 22 pulls on the face of plate 28, then plate 28 is pulled solidly against box 30, and pulls on vehicle body 12, just as if plate 28 were rigidly fixed to body 12. Further details of the electrical features of cinching mechanism 16 are described next.

Referring next to FIGS. 2A and 2B, a first circuit 34, when it carries current, acts to both energize magnet 22 and to run motor 26 in a direction that pulls jackscrew 24 and magnet 22 inwardly. A second circuit 36, when it carries current, runs motor 26 (and jack screw 26 and magnet 22) in the opposite direction, but does not energize magnet 22. The two circuits 34 and 36 are selected and energized, or not, by a sensor and switch means, indicated generally at 38. Sensor and switch means 38 includes a spring loaded paddle switch 40, which is biased toward the full out position shown in FIG. 2, but which is depressed below that position as soon as lift gate 10 reaches its cinch ready position, when the paddle switch 40 concurrently hits a solid stop 42 on the vehicle body 12. Paddle switch 40, if it is depressed at all below its full out position, sends current to first circuit 34, if the first circuit 34 is otherwise selected. In its full out position, paddle switch 40 sends current to the second circuit 36, if it is otherwise selected. The two circuits 34 and 36 are selected, or not, by another means, an over center switch 44, which is snapped up, or down, by cooperating spaced tabs 46 that move with the body of magnet 22. When snapped up, as shown in FIG. 2A, (magnet 22 pushed out), over center switch 44 shifts three terminals X, Y and Z to the position shown, to select the first circuit 34. When snapped down (magnet 22 pulled inwardly), over center switch 44 shifts the three terminals X, Y and Z in the opposite direction, to select the second circuit 36 This inter relation of circuits and switches operates as described below.

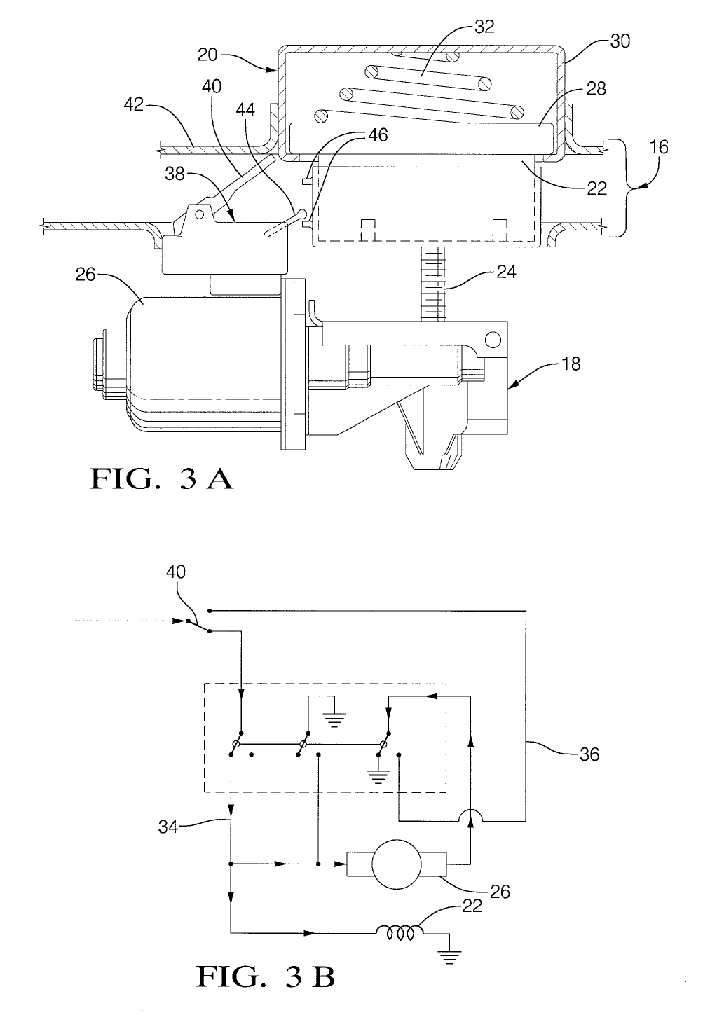

Referring next to FIGS. 2A, 2B, 3A and 3B, the initial closing of lift gate 10 from its fully open position is illustrated. In FIGS. 2A and 2B, the mechanical and electrical state of the cinching mechanism 16 is illustrated when lift gate 10 is at any position opened past or beyond its cinch ready position. That is, lift gate 10 will not yet have encountered any significant resistance to closing, if it is being swung closed. In this state, the magnet 22 is extended fully outwardly, to a cinch ready position, the paddle switch 40 is sprung fully out, and the over center switch 44 is snapped up. As such, the terminals X, Y and Z have first circuit 34 selected and ready to be energized, as soon as paddle switch 40 is depressed below its full out position. The selected circuit is not yet carrying current, however. As lift gate 10 is closed sufficiently to reach its cinch ready position, the face of magnet 22 contacts the face of plate 28, ideally just as the paddle switch 40 hits stop 42 and begins to be depressed, as shown in FIG. 3A. Now, as shown in FIG. 3B, the selected and ready first circuit 34 is energized by the depressed paddle switch 40, and current flows in the direction shown by the arrows, acting both to retract magnet 22 with the turning jack screw 24, and to energize magnet 22. As such, paddle switch 40 acts as a sensor as well as a switch. Magnet 22 begins to pull in on box 30, and on vehicle body 12, pulling lift gate 10 in as well. Over center switch 44 is as yet unaffected, being clear between the spaced tabs 46.

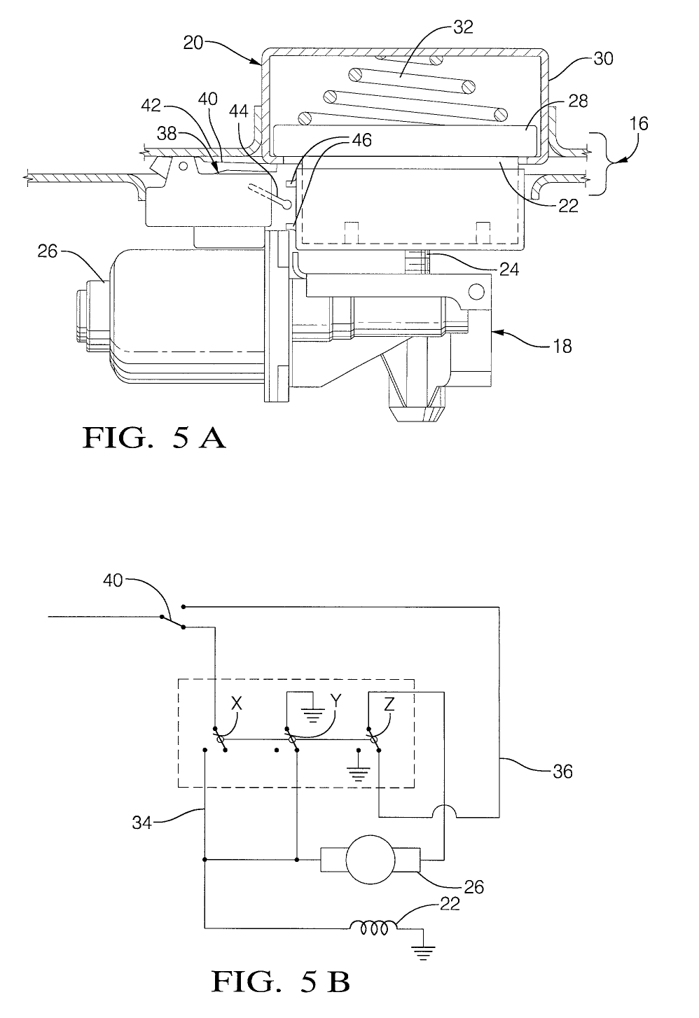

Referring next to FIGS. 4, 5A and 5B, the continued cinching motion of lift gate 10 is illustrated. As shown in FIG. 4, as magnet 22 continues to retract and pull lift gate 10 inwardly, the latches 14 would begin to move toward their fully latched position. The electrical state remains the same as in FIG. 3B, since no switch has yet been physically contacted to change its position or deselect a circuit. Now, however, the over center switch 44 begins to approach the upper tab 46. Finally, as shown in FIG. 5A, the magnet 22 is moved fully in, the latches 14 fully engage, lift gate 10 fully closes, and the over center switch 44 is snapped down by the upper tab 46. As seen in FIG. 5B, the over center switch 44 acts as a sensor that reacts when the fully closed position has been reached, as well as a switch, since the three terminals X, Y and Z are flipped over to de select the first circuit 34 and select the second circuit 36. This de energizes motor 26 and magnet 22 both. The tab spacing at 46 is set so as to assure that the magnet 22 moves over a sufficient travel distance to latch the latches 14 fully, but no more. Since paddle switch 40 is still depressed, it is unable yet to energize the now selected second circuit 36, and no current flows through it, although it is poised and ready to do so, as soon as it is released to spring back to its full out position.

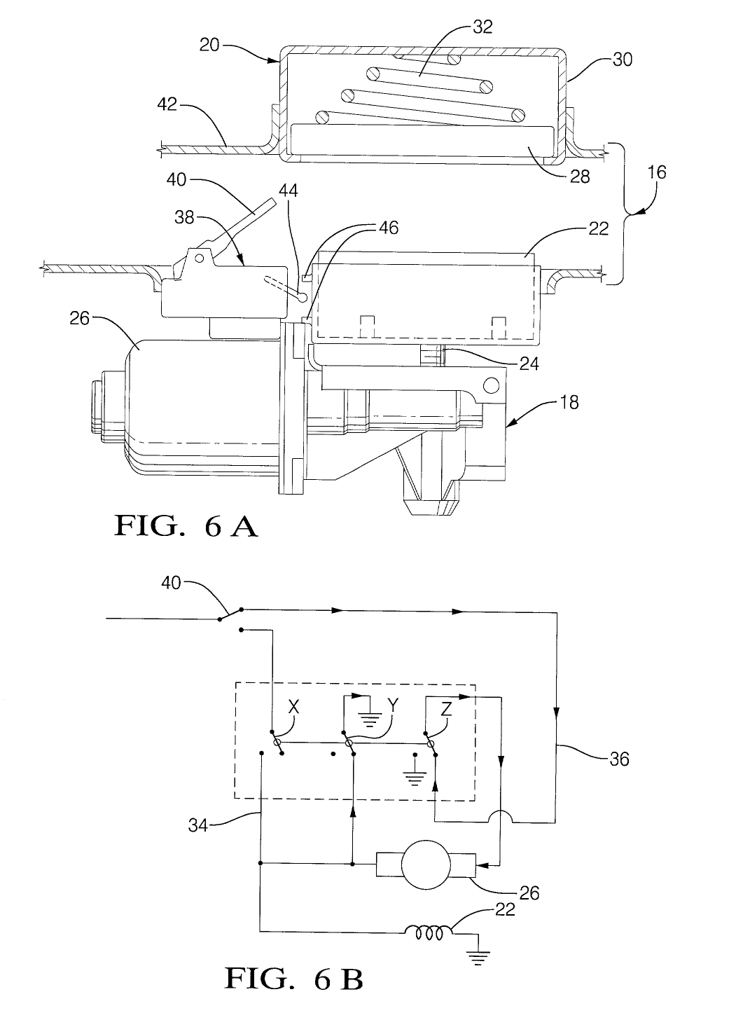

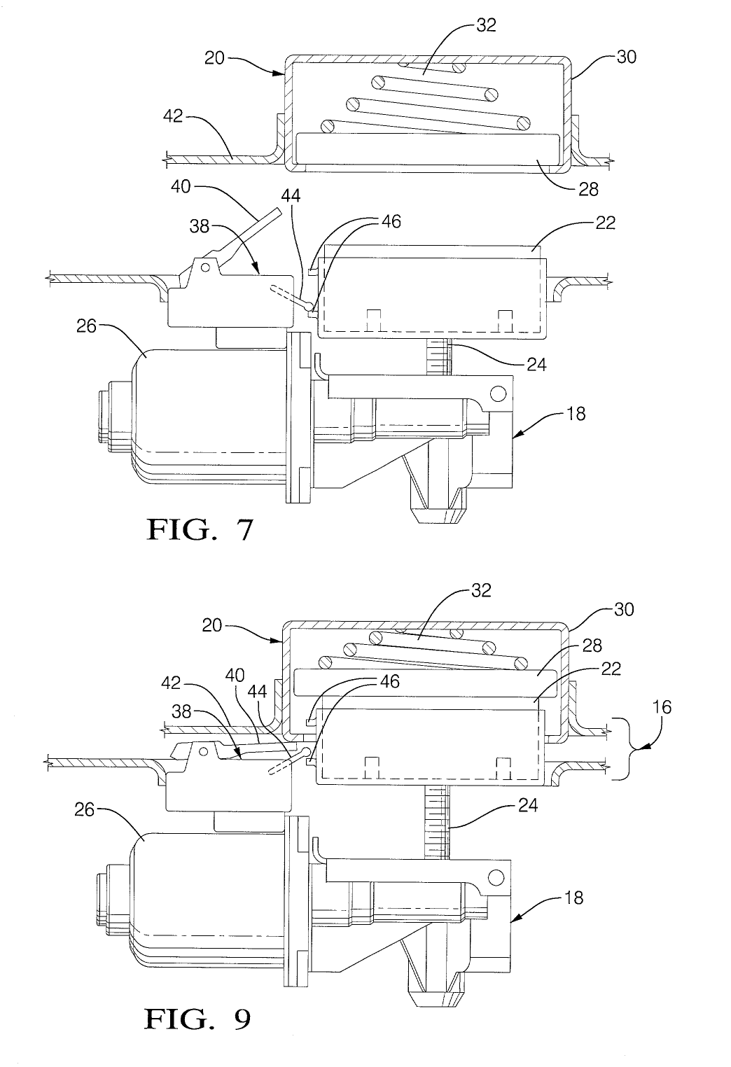

Referring next to FIGS. 6A, 6B and 7, the motion of lift gate 10 and the cinching mechanism 16 after release of the latches 14 is illustrated. The latches 14 would be released by any suitable and conventional means, causing them to release their stored energy to quickly pop the lift gate 10 partially open. Lift gate 10 moves far enough to release the spring loaded paddle switch 40 back to its full out position, either immediately, or when the lift gate 10 is opened farther. This allows the already selected second circuit 36 to be energized, as shown in FIG. 6B, which runs the motor 26 in the opposite direction, extending the magnet 22 back to it's “cinch ready” position, but without energizing the magnet 22. Magnet 22 is extended by jackscrew 24 until the over center switch 44 begins to engage the lower tab 46, as shown in FIG. 7.

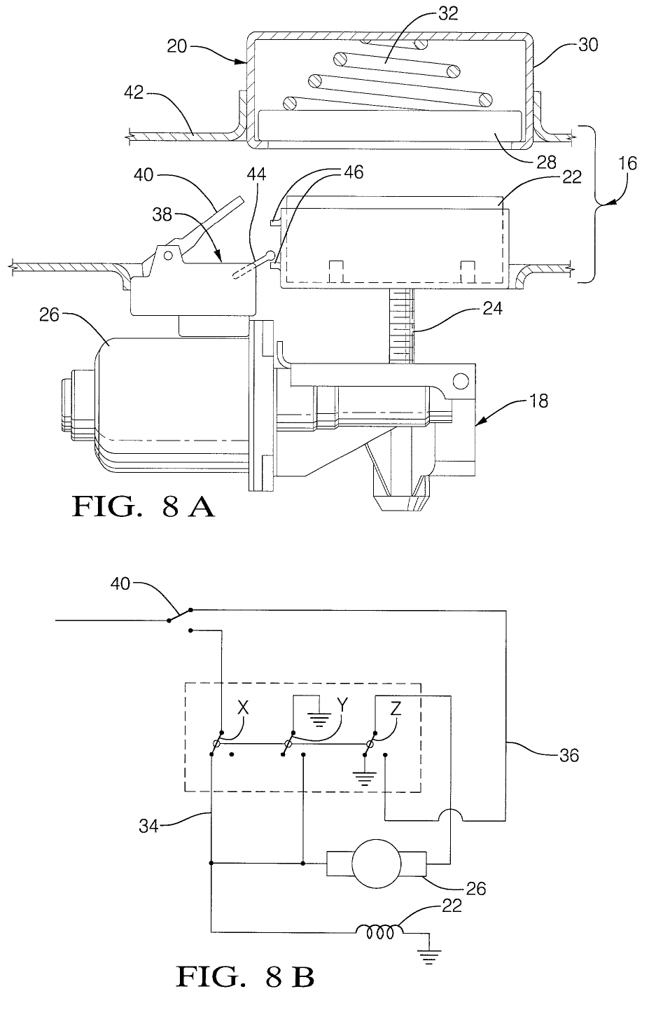

Referring finally to FIGS. 8A and 8B, as magnet 22 extends fully back out to its original cinch ready position, the over center switch 44 is contacted by the lower tab 46 and then snapped back up, de selecting the second circuit 36 and re selecting the first circuit 34 (FIG. 8B). The first circuit 34 is not energized, however, since the paddle switch 40 is still at its full out position. Magnet 22 is thus reset back to its original or cinch ready position, so that FIGS. 8A and 8B are identical to 2A and 2B, insofar as the relative component position and state.

Reviewing the above operation, one obvious benefit of the invention is the basic de coupling of the cinching mechanism 16 from the conventional latches 14. This alone allows for an easy retrofit of the cinching mechanism 16 to an existing design that has conventional latches, with no change to the structure or operation of the conventional latches. Or, two different vehicle models, one with and one without powered cinching, could be provided on the same basic platform. An even larger benefit is the elimination of any need for a manual disabling device, of the type described above, to serve in the event of electrical failure. There is no mechanical “hooking” of one part around another, such as a fork bolt around a striker, only the face to face contact of magnet 22 and plate 28. Therefore, should electrical power fail at any point, then the electromagnet 22 simply releases from plate 22, with no need for mechanical undoing or reversal of anything. If the lift gate 10 is fully closed, magnet 22 fully retracted and the power to cinching mechanism fails, simply releasing the latches 14 will allow lift gate 10 to be opened normally. The lift gate operation resorts automatically to manual operation, with no other steps or structures needed. Should power fail at any point during door closing, or after it is opened, so that the magnet 22 is extended past the fully retracted position and “frozen” in place, another feature noted above comes into play.

Referring next to FIG. 9, the condition in which magnet 22 is fully extended, and disabled from retracting by a power failure, is illustrated. The lift gate 10 may simply be shut manually, which will push the magnet 22 into plate 28. As noted above, box 30 is deep enough to allow spring plate 28 and 32 to yield by the “travel distance,” to compress enough to accommodate this unlikely, but possible, condition. Moreover, the spring 32 could accommodate lesser misalignments of the face of magnet 22 and plate 28 resulting from normal build tolerances.

Variations in the disclosed embodiment could be made. As noted above, the two basic parts 18 and 20 could be mounted to either the lift gate 10 or body 12, but it is most convenient, in terms of available space, to mount the motor 26 inside the cavity of lift gate 10. The magnet 22 could be advanced and retracted by other devices, but a jack screw 24 and motor 26 combination is simple and well tested. Likewise, other sensor and switch means could be used to sense the location and direction of lift gate 10, but the simple, essentially mechanical switches 40 and 44 are also well tested. The cinching mechanism 16 could also be added to a power opened and closed lift gate 10, in order to provide the greater force needed for the final cinch. The over slam protection built into and behind the plate 28 is not absolutely necessary, assuming either that an electric failure with the magnet 22 advanced is not considered likely, or if some other simple means is provided to retract the magnet 22 in that event. Likewise, providing the yielding potential with a compression spring like 32 is convenient, since it automatically re sets itself, but the plate 28 could be designed simply to push back non resiliently, on a one time basis. Therefore, it will be understood that it is not intended to limit the invention to just the embodiment disclosed.

1. For use in a vehicle with a closure panel movable from a fully open, to a substantially closed, to a fully closed position, said vehicle having a releasable mechanical closure panel latch that begins to engage when said panel moves to the substantially closed position and which fully engages when said closure panel is moved forcibly over a pre determined travel distance from the substantially to the fully closed position, and which allows the closure panel to move back toward the substantially closed position when released, an electromechanical cinching mechanism to actively move said closure panel over said predetermined travel distance, comprising,
a bi-directional, electrically powered prime mover fixed to one of said closure panel and vehicle which selectively moves, when activated, in opposite directions over said predetermined travel distance and with a closing force sufficient to forcibly pull said closure panel fully closed,
an electromagnet fixed to said prime mover having sufficient strength to provide said closing force,
a magnetic plate fixed to the other of said closure panel and vehicle and located so as to engage said electromagnet when said closure panel moves from the fully open to the substantially closed position,
a first circuit adapted to retract said prime mover and electromagnet while simultaneously activating said electromagnet and a second circuit mean adapted to retract said prime mover and electromagnet without activating said electromagnet,
sensor and switch means adapted to energize said first circuit as said closure panel moves from the fully open to the substantially closed position, thereby allowing said prime mover and activated electromagnet to engage said magnetic plate and move said closure panel to the fully closed position and engage said mechanical latch, said sensor and switch means also being adapted to de energize said first circuit as said closure panel reaches the fully closed position, to energize said second circuit as said mechanical latch is released and said closure panel moves back to the substantially closed position, and to de energize said second circuit after said prime mover has moved back over the predetermined travel distance.

2. An electromechanical cinching mechanism according to claim 1, further characterized in that said prime mover is an electric motor and a jack screw.

3. An electromechanical cinching mechanism according to claim 2, further characterized in that said electric motor and jack screw are fixed to said door, and said electromagnetic plate is fixed to said vehicle body.

4. An electromechanical cinching mechanism according to claim 1, further characterized in that said magnetic plate is mounted so as to yield by said travel distance, and so allow said closure panel to close in the event that said electromagnet cannot retract fully.

5. An electromechanical cinching mechanism according to claim 4, in which said magnetic plate is mounted so as to yield resiliently by said travel distance.

6. An electromechanical cinching mechanism according to claim 1, in which said sensor and switch means includes an over center switch adapted to select between said first and second circuits as said electromagnet moves over said travel distance.
